(19) United States
(12) Patent Application Publication
(10) Pub. No.: US 2026/0216714 A1
(43) Pub. Date: Jul. 30, 2026

(54) CATALYSTS SUITABLE FOR HYDROCRACKING

(71) Applicant: Saudi Arabian Oil Company, Dhahran (SA)

(72) Inventors: Guanghui Zhu, Dhahran (SA); Lianhui Ding, Dhahran (SA); Faisal M. Almulla, Dhahran (SA); Khaled Saloomi, Dhahran (SA)

(73) Assignee: Saudi Arabian Oil Company, Dhahran (SA)

(21) Appl. No.: 19/040,511

(22) Filed: Jan. 29, 2025

(51) Int. Cl. B01J 29/78; B01J 23/888; B01J 35/61; B01J 35/63; B01J 35/64; B01J 37/02; B01J 37/03; B01J 37/08; C01B 39/48; C10G 47/20

(52) U.S. Cl. CPC B01J 29/7815; B01J 23/888; B01J 35/615; B01J 35/633; B01J 35/647; B01J 37/0201; B01J 37/036; B01J 37/08; C01B 39/48; C10G 47/20; B01J 2229/186; C01P 2004/64; C01P 2006/12; C01P 2006/14; C01P 2006/17

(57) ABSTRACT

A method of hydrocracking a hydrocarbon feed comprises contacting the hydrocarbon feed with a catalyst suitable for hydrocracking in the presence of molecular hydrogen in a reactor to crack at least a portion of the hydrocarbon feed to form a product, wherein the hydrocarbon feed has a 5 wt. % boiling point from 250° C. to 500° C. and 95 wt. % boiling point from 450° C. to 650° C. The catalyst comprises from 0.1 wt. % to 10 wt. % of a zeolite Beta having a particle size of 100 nm or less; from 10 wt. % to 70 wt. % of amorphous silica alumina; from 10 wt. % to 40 wt. % of porous alumina; and from 10 w % to 35 wt. % of one or more metal oxides.

### FIELD

The present disclosure generally relates to catalysts and, more specifically, to catalysts suitable for hydrocracking.

### BACKGROUND

Hydrocracking is a versatile catalytic process that, typically, converts heavy oils to lighter products by aromatic saturation, cracking, and/or isomerization reactions in the presence of hydrogen. These hydrocracking treatments may utilize catalysts that can at least partially crack the large molecules present in the heavy oils. However, conventional catalysts may have poor cracking conversion.

### SUMMARY

Accordingly, new catalysts suitable for hydrocracking with various improved attributes are needed. As described herein, it has been discovered that particular catalyst compositions may have good performance in hydrocracking specific hydrocarbon feeds that have, for example, a 5 wt. % boiling point from 250° C. to 500° C. and a 95 wt. % boiling point from 450° C. to 650° C. Surprisingly, for such feeds, it has been presently discovered that catalysts that include zeolite Beta, amorphous silica, porous alumina, and metal oxide, in particular amounts, may have superior catalytic performance as compared with conventional hydrocracking catalysts. Without being bound by any particular theory, it is believed that utilizing such catalysts may provide relatively high yields of middle distillates, which are valuable products in industry.

According to one or more embodiments, a method of cracking a hydrocarbon feed method comprises contacting the hydrocarbon feed with a catalyst in the presence of molecular hydrogen to crack at least a portion of the hydrocarbon feed to form a product; wherein the catalyst comprises: from 0.1 wt. % to 10 wt. % of a zeolite Beta having an average particle size less than or equal to 100 nm; from 20 wt. % to 70 wt. % of amorphous silica alumina; from 10 wt. % to 40 wt. % of porous alumina; and from 10 wt. % to 35 wt. % of one or more metal oxides; and wherein the hydrocarbon feed has a 5 wt. % boiling point from 250° C. to 500° C. and a 95 wt. % boiling point from 450° C. to 650° C.

This summary is provided to introduce a selection of concepts that are further described in the detailed description. This summary is not intended to identify key or essential features of the claimed subject matter, nor is it intended to be used as an aid in limiting the scope of the claimed subject matter.

Additional features and advantages of the described embodiments will be set forth in the detailed description that follows. The additional features and advantages of the described embodiments will be, in part, readily apparent to those skilled in the art from that description or recognized by practicing the described embodiments, including the detailed description that follows as well as the claims.

### DETAILED DESCRIPTION

The present disclosure is directed to methods of cracking hydrocarbon feeds. As described herein, such methods may comprise contacting the hydrocarbon feed with a catalyst in the presence of molecular hydrogen to crack at least a portion of the hydrocarbon feed to form a product.

According to one or more embodiments, the hydrocarbon feed may be cracked by a method that comprises contacting the hydrocarbon feed with a catalyst in the presence of molecular hydrogen to crack at least a portion of the hydrocarbon feed to form a product. As used in the present disclosure, “hydrocarbon feed” generally refers to material composed primarily of hydrocarbons (organic compounds made of hydrogen and carbon atoms) that may be industrial processes to produce various chemical products, fuels, or materials. As used in the present disclosure, the term “cracking” generally refers to a chemical reaction where a molecule having carbon-to-carbon bonds (e.g., components of a hydrocarbon feed) is broken into more than one molecule by the breaking of one or more of the carbon to carbon bonds or is converted from a compound which includes a cyclic moiety, such as a cycloalkane, cycloalkane, naphthalene, an aromatic or the like, to a compound which does not include a cyclic moiety or contains fewer cyclic moieties than prior to cracking. As described herein, cracking in the presence of molecular hydrogen may be referred to as “hydrocracking,” as would be understood by those skilled in the art. In general, hydrocracking is a process combining catalytic cracking and hydrogenation, wherein heavier hydrocarbon feeds are cracked in the presence of molecular hydrogen to produce more desirable lighter hydrocarbon products. This is an important technology for producing hydrocarbon products from a wide range of refinery hydrocarbon feeds. As used in the present disclosure, the term “catalyst” refers to any substance that increases the rate of a specific chemical reaction.

In one or more embodiments, the catalyst compositions described herein may have good performance in hydrocracking specific hydrocarbon feeds that have, for example, an initial boiling point from 200° C. to 450° C., a 5 wt. % boiling point from 250° C. to 500° C., a 10 wt. % boiling point from 300° C. to 550° C., a 50 wt. % boiling point from 350° C. to 600° C., a 95 wt. % boiling point from 450° C. to 650° C., and/or a final boiling point from 500° C. to 800° C.

In one or more embodiments, the hydrocarbon feed may have an initial boiling point temperature from 200° C. to 450° C., as determined according to standard test method ASTM D7169. As used in the present disclosure, the term “initial boiling point” refers to the temperature at which the first drop of the fluid begins to vaporize during a distillation process. It represents the temperature at which the most volatile components of the mixture, typically the lightest hydrocarbons, start to evaporate. For example, and without limitation, in one or more embodiments, the hydrocarbon feed may have an initial boiling point temperature from 200° C. to 450° C., 200° C. to 425° C., 200° C. to 400° C., 200° C. to 375° C., 200° C. to 350° C., 200° C. to 325° C., 200° C. to 300° C., 200° C. to 275° C., 200° C. to 250° C., 200° C. to 225° C., 225° C. to 450° C., 225° C. to 425° C., 225° C. to 400° C., 225° C. to 375° C., 225° C. to 350° C., 225° C. to 325° C., 225° C. to 300° C., 225° C. to 275° C., 225° C. to 250° C., 250° C. to 450° C., 250° C. to 425° C., 250° C. to 400° C., 250° C. to 375° C., 250° C. to 350° C., 250° C. to 325° C., 250° C. to 300° C., 250° C. to 275° C., 275° C. to 450° C., 275° C. to 425° C., 275° C. to 400° C., 275° C. to 375° C., 275° C. to 350° C., 275° C. to 325° C., 275° C. to 300° C., 300° C. to 450° C., 300° C. to 425° C., 300° C. to 400° C., 300° C. to 375° C., 300° C. to 350° C., 300° C. to 325° C., 325° C. to 450° C., 325° C. to 425° C., 325° C. to 400° C., 325° C. to 375° C., 325° C. to 350° C., 350° C. to 450° C., 350° C. to 425° C., 350° C. to 400° C., 350° C. to 375° C., 375° C. to 450° C., 375° C. to 425° C., 375° C. to 400° C., 400° C. to 450° C., 400° C. to 425° C., or even from 425° C. to 400° C., or a range where any two listed numbers comprise the endpoints of that range, as determined according to standard test method ASTM D7169.

In one or more embodiments, the hydrocarbon feed may have a 5 wt. % boiling point temperature from 250° C. to 500° C. As used in the present disclosure, the term “5 wt. % boiling point” refers to the temperature at which 5% of the total mass of the hydrocarbon fluid has vaporized during a distillation process. For example, and without limitation, in one or more embodiments, the hydrocarbon feed may have a 5 wt. % boiling point temperature from 250° C. to 500° C., 250° C. to 475° C., 250° C. to 450° C., 250° C. to 425° C., 250° C. to 400° C., 250° C. to 375° C., 250° C. to 350° C., 250° C. to 325° C., 250° C. to 300° C., 250° C. to 275° C., 275° C. to 500° C., 275° C. to 475° C., 275° C. to 450° C., 275° C. to 425° C., 275° C. to 400° C., 275° C. to 375° C., 275° C. to 350° C., 275° C. to 325° C., 275° C. to 300° C., 300° C. to 500° C., 300° C. to 475° C., 300° C. to 450° C., 300° C. to 425° C., 300° C. to 400° C., 300° C. to 375° C., 300° C. to 350° C., 300° C. to 325° C., 325° C. to 500° C., 325° C. to 475° C., 325° C. to 450° C., 325° C. to 425° C., 325° C. to 400° C., 325° C. to 375° C., 325° C. to 350° C., 350° C. to 500° C., 350° C. to 475° C., 350° C. to 450° C., 350° C. to 425° C., 350° C. to 400° C., 350° C. to 375° C., 375° C. to 500° C., 375° C. to 475° C., 375° C. to 450° C., 375° C. to 425° C., 375° C. to 400° C., 400° C. to 450° C., 400° C. to 500° C., 400° C. to 475° C., 400° C. to 425° C., 425° C. to 500° C., 425° C. to 475° C., 425° C. to 450° C., 450° C. to 500° C., 450° C. to 475° C., or even from 475° C. to 500° C., or a range where any two listed numbers comprise the endpoints of that range, as determined according to standard test method ASTM D7169.

In one or more embodiments, the hydrocarbon feed may have a 10 wt. % boiling point temperature from 300° C. to 550° C. As used in the present disclosure, the term “10 wt. % boiling point” refers to the temperature at which 10% of the total mass of the hydrocarbon fluid has vaporized during a distillation process. For example, and without limitation, in one or more embodiments, the hydrocarbon feed may have a 10 wt. % boiling point temperature from 300° C. to 550° C., 300° C. to 525° C., 300° C. to 500° C., 300° C. to 475° C., 300° C. to 450° C., 300° C. to 425° C., 300° C. to 400° C., 300° C. to 375° C., 300° C. to 350° C., 300° C. to 325° C., 325° C. to 550° C., 325° C. to 525° C., 325° C. to 500° C., 325° C. to 475° C., 325° C. to 450° C., 325° C. to 425° C., 325° C. to 400° C., 325° C. to 375° C., 325° C. to 350° C., 350° C. to 550° C., 350° C. to 525° C., 350° C. to 500° C., 350° C. to 475° C., 350° C. to 450° C., 350° C. to 425° C., 350° C. to 400° C., 350° C. to 375° C., 375° C. to 550° C., 375° C. to 525° C., 375° C. to 500° C., 375° C. to 475° C., 375° C. to 450° C., 375° C. to 425° C., 375° C. to 400° C., 400° C. to 550° C., 400° C. to 525° C., 400° C. to 450° C., 400° C. to 500° C., 400° C. to 475° C., 400° C. to 425° C., 425° C. to 550° C., 425° C. to 525° C., 425° C. to 500° C., 425° C. to 475° C., 425° C. to 450° C., 450° C. to 550° C., 450° C. to 525° C., 450° C. to 500° C., 450° C. to 475° C., 475° C. to 550° C., 475° C. to 525° C., 475° C. to 500° C., 500° C. to 550° C., 500° C. to 525° C., or even from 525° C. to 550° C., or a range where any two listed numbers comprise the endpoints of that range, as determined according to standard test method ASTM D7169.

In one or more embodiments, the hydrocarbon feed may have a 50 wt. % boiling point temperature from 350° C. to 600° C. As used in the present disclosure, the term “50 wt. % boiling point” refers to the temperature at which 50% of the total mass of the hydrocarbon fluid has vaporized during a distillation process. For example, and without limitation, in one or more embodiments, the hydrocarbon feed may have a 50 wt. % boiling point temperature from 350° C. to 600° C., 350° C. to 575° C., 350° C. to 550° C., 350° C. to 525° C., 350° C. to 500° C., 350° C. to 475° C., 350° C. to 450° C., 350° C. to 425° C., 350° C. to 400° C., 350° C. to 375° C., 375° C. to 600° C., 375° C. to 575° C., 375° C. to 550° C., 375° C. to 525° C., 375° C. to 500° C., 375° C. to 475° C., 375° C. to 450° C., 375° C. to 425° C., 375° C. to 400° C., 400° C. to 600° C., 400° C. to 575° C., 400° C. to 550° C., 400° C. to 525° C., 400° C. to 450° C., 400° C. to 500° C., 400° C. to 475° C., 400° C. to 425° C., 425° C. to 600° C., 425° C. to 575° C., 425° C. to 550° C., 425° C. to 525° C., 425° C. to 500° C., 425° C. to 475° C., 425° C. to 450° C., 450° C. to 600° C., 450° C. to 575° C., 450° C. to 550° C., 450° C. to 525° C., 450° C. to 500° C., 450° C. to 475° C., 475° C. to 600° C., 475° C. to 575° C., 475° C. to 550° C., 475° C. to 525° C., 475° C. to 500° C., 500° C. to 600° C., 500° C. to 575° C., 500° C. to 550° C., 500° C. to 525° C., 525° C. to 600° C., 525° C. to 575° C., 525° C. to 550° C., 550° C. to 600° C., 550° C. to 575° C., or even from 575° C. to 600° C., or a range where any two listed numbers comprise the endpoints of that range, as determined according to standard test method ASTM D7169.

In one or more embodiments, the hydrocarbon feed may have a 95 wt. % boiling point temperature from 450° C. to 650° C. As used in the present disclosure, the term “95 wt. % boiling point” refers to the temperature at which 95% of the total mass of the hydrocarbon fluid has vaporized during a distillation process. For example, and without limitation, in one or more embodiments, the hydrocarbon feed may have a 95 wt. % boiling point temperature from 450° C. to 600° C., 450° C. to 575° C., 450° C. to 550° C., 450° C. to 525° C., 450° C. to 500° C., 450° C. to 475° C., 475° C. to 650° C., 475° C. to 625° C., 475° C. to 600° C., 475° C. to 575° C., 475° C. to 550° C., 475° C. to 525° C., 475° C. to 500° C., 500° C. to 650° C., 500° C. to 625° C., 500° C. to 600° C., 500° C. to 575° C., 500° C. to 550° C., 500° C. to 525° C., 525° C. to 650° C., 625° C. to 625° C., 525° C. to 600° C., 525° C. to 575° C., 525° C. to 550° C., 550° C. to 650° C., 550° C. to 625° C., 550° C. to 600° C., 550° C. to 575° C., 575° C. to 650° C., 575° C. to 625° C., 575° C. to 600° C., 600° C. to 650° C., 600° C. to 625° C., or even from 625° C. to 650° C., or a range where any two listed numbers comprise the endpoints of that range, as determined according to standard test method ASTM D7169.

In one or more embodiments, the hydrocarbon feed may have a final boiling point temperature from 450° C. to 650° C. As used in the present disclosure, the term “final boiling point” refers to the temperature at which the last remaining drop of liquid in the sample completely vaporizes during a distillation process. It represents the boiling point at which the heaviest and least volatile components of the fluid, typically the higher molecular weight hydrocarbons, transition into the vapor phase. For example, and without limitation, in one or more embodiments, the hydrocarbon feed may have a final boiling point temperature from 500° C. to 800° C., 500° C. to 775° C., 500° C. to 750° C., 500° C. to 725° C., 500° C. to 700° C., 500° C. to 675° C., 500° C. to 650° C., 500° C. to 625° C., 500° C. to 600° C., 500° C. to 575° C., 500° C. to 550° C., 500° C. to 525° C., 525° C. to 800° C., 525° C. to 775° C., 525° C. to 750° C., 525° C. to 725° C., 525° C. to 700° C., 525° C. to 675° C., 525° C. to 650° C., 625° C. to 625° C., 525° C. to 600° C., 525° C. to 575° C., 525° C. to 550° C., 550° C. to 800° C., 550° C. to 775° C., 550° C. to 750° C., 550° C. to 725° C., 550° C. to 700° C., 550° C. to 675° C., 550° C. to 650° C., 550° C. to 625° C., 550° C. to 600° C., 550° C. to 575° C., 575° C. to 800° C., 575° C. to 775° C., 575° C. to 750° C., 575° C. to 725° C., 575° C. to 700° C., 575° C. to 675° C., 575° C. to 650° C., 575° C. to 625° C., 575° C. to 600° C., 600° C. to 800° C., 600° C. to 775° C., 600° C. to 750° C., 600° C. to 725° C., 600° C. to 700° C., 600° C. to 675° C., 600° C. to 650° C., 600° C. to 625° C., 625° C. to 800° C., 625° C. to 775° C., 625° C. to 750° C., 625° C. to 725° C. 625° C. to 700° C., 625° C. to 675° C., 625° C. to 650° C., 650° C. to 800° C., 650° C. to 775° C., 650° C. to 750° C., 650° C. to 725° C., 650° C. to 700° C., 650° C. to 675° C., 675° C. to 800° C., 675° C. to 775° C., 675° C. to 750° C., 675° C. to 725° C., 675° C. to 700° C., 700° C. to 800° C., 700° C. to 775° C., 700° C. to 750° C., 700° C. to 725° C., 725° C. to 800° C., 725° C. to 775° C., 725° C. to 750° C., 750° C. to 800° C., 750° C. to 775° C., or even from 775° C. to 800° C., or a range where any two listed numbers comprise the endpoints of that range, as determined according to standard test method ASTM D7169.

In one or more embodiments, the hydrocarbon feed may comprise refined oil obtained from crude oil, synthetic crude oil, bitumen, oil sand, shell oil, coal liquid, or combinations thereof. In one or more embodiments, the hydrocarbon feed may comprise (a) vacuum gas oil (VGO), (b) deasphalted oil (DAO) obtained from a solvent deasphalting process or demetalled oil, (c) light coker gas oil or heavy coker gas oil obtained from a coker process, (d) cycle oil obtained from a fluid catalytic cracking (FCC) process, (e) gas oil obtained from a visbraking process, or combinations thereof. However, the source of the hydrocarbon feed is not necessarily limited, and it is contemplated that a wide variety of sourced hydrocarbons are suitable for use in the methods described herein.

In one or more embodiments, the method of contacting the hydrocarbon feed with a catalyst in the presence of molecular hydrogen to crack at least a portion of the hydrocarbon feed may produce a cracked effluent (i.e., a product).

In one or more embodiments, the product produced from the method discussed herein may comprise hydrocarbons comprising gas, naphtha (e.g., light and heavy naphtha), kerosene, and diesel. As used in the present disclosure, the term “gas” refers to C1-C4 hydrocarbons. As used in the present disclosure, the term “naphtha” refers to hydrocarbons having at least five carbons and a boiling point less than or equal to 150° C. As used in the present disclosure, the term “light naphtha” refers to hydrocarbons having at least five carbons and a boiling point less than or equal to 75° C. As used in the present disclosure, the term “heavy naphtha” refers to hydrocarbons having a boiling point from 75° C. to 150° C. As used in the present disclosure, the term “kerosene” refers to hydrocarbons having a boiling point from 150° C. to 250° C. As used in the present disclosure, the term “diesel” refers to hydrocarbons having a boiling point from 250° C. to 375° C.

In one or more embodiments, the method discussed herein may provide relatively high yields of middle distillate products. As used in the present disclosure, the term “middle distillates” refers to hydrocarbons having a boiling point from 150° C. to 375° C. (e.g., kerosene and/or diesel, as described herein).

In one or more embodiments, the product of the cracked hydrocarbon feed may comprise greater than or equal to 35 wt. % of hydrocarbons having a boiling point from 150° C. to 375° C., based on the total weight of the hydrocarbon feed. For example, and without limitation, in one or more embodiments, the product of the cracked hydrocarbon feed may comprise hydrocarbons having a boiling point from 150° C. to 375° C., based on a total weight of the hydrocarbon feed, greater than or equal to 35 wt. %, greater than or equal to 36 wt. %, greater than or equal to 37 wt. %, greater than or equal to 38 wt. %, greater than or equal to 39 wt. %, greater than or equal to 40 wt. %, greater than or equal to 41 wt. %, greater than or equal to 42 wt. %, greater than or equal to 43 wt. %, greater than or equal to 44 wt. %, greater than or equal to 45 wt. %, greater than or equal to 46 wt. %, greater than or equal to 47 wt. %, greater than or equal to 48 wt. %, greater than or equal to 49 wt. %, or even greater than or equal to 50 wt. %.

In one or more embodiments, the product of the cracked hydrocarbon feed may comprise greater than or equal to 20 wt. % of hydrocarbons having a boiling point from 250° C. to 375° C., based on the total weight of the hydrocarbon feed. For example, and without limitation, in one or more embodiments, the product of the cracked hydrocarbon feed may comprise hydrocarbons having a boiling point from 250° C. to 375° C., based on a total weight of the hydrocarbon feed, greater than or equal to 20 wt. %, greater than or equal to 21 wt. %, greater than or equal to 22 wt. %, greater than or equal to 23 wt. %, greater than or equal to 24 wt. %, greater than or equal to 25 wt. %, greater than or equal to 26 wt. %, greater than or equal to 27 wt. %, greater than or equal to 28 wt. %, greater than or equal to 29 wt. %, greater than or equal to 30 wt. %, greater than or equal to 31 wt. %, greater than or equal to 32 wt. %, greater than or equal to 33 wt. %, greater than or equal to 34 wt. %, greater than or equal to 35 wt. %, greater than or equal to 36 wt. %, greater than or equal to 37 wt. %, greater than or equal to 38 wt. %, greater than or equal to 39 wt. %, greater than or equal to 40 wt. %, greater than or equal to 41 wt. %, greater than or equal to 42 wt. %, greater than or equal to 43 wt. %, greater than or equal to 44 wt. %, greater than or equal to 45 wt. %, greater than or equal to 46 wt. %, greater than or equal to 47 wt. %, greater than or equal to 48 wt. %, greater than or equal to 49 wt. %, or even greater than or equal to 50 wt. %.

As is described herein, the catalyst used in the methods described herein may increase the conversion of the hydrocarbon feed to middle distillate products compared to conventional catalysts. According to one or more embodiments, as is described herein, the catalyst may comprise zeolite Beta, amorphous silica alumina, porous alumina, and one or more metal oxides.

As used throughout this disclosure, and as would be understood by those skilled in the art, “zeolites” may refer to micropore-containing inorganic materials with regular intra-crystalline cavities and channels of molecular dimension. As is understood by those skilled in the art, and as used in this disclosure, “zeolite Beta” refers to a type of zeolite having a BEA framework type, according to the International Zeolite Association (“IZA”), zeolite nomenclature, and consists mainly of silica and alumina. The molar ratio of silica to alumina in the zeolite Beta may be 5 or greater, 10 or greater, 25 or greater, or even 100 or greater. For example, the molar ratio of silica to alumina in the zeolite Beta may be from 5 to 500, such as from 10 to 50. The silica to alumina ratio can be measured by X-ray Fluorescence (“XRF”) spectrometry, as would be understood by those skilled in the art.

In one or more embodiments, the catalyst may comprise from 0.1 wt. % to 10 wt. % of a zeolite Beta, as described herein, based on the total weight of the catalyst. For example, and without limitation, in one or more embodiments, the catalyst described herein may comprise a zeolite Beta in an amount, based on the total weight of the catalyst, from 0.1 wt. % to 10 wt. %, 0.1 wt. % to 9 wt. %, 0.1 wt. % to 8 wt. %, 0.1 wt. % to 7 wt. %, 0.1 wt. % to 6 wt. %, 0.1 wt. % to 5 wt. %, 0.1 wt. % to 4 wt. %, 0.1 wt. % to 3 wt. %, 0.1 wt. % to 2, 0.1 wt. % to 1 wt. %, 1 wt. % to 10 wt. %, 1 wt. % to 9 wt. %, 1 wt. % to 8 wt. %, 1 wt. % to 7 wt. %, 1 wt. % to 6 wt. %, 1 wt. % to 5 wt. %, 1 wt. % to 4 wt. %, 1 wt. % to 3 wt. %, 1 wt. % to 2, 2 wt. % to 10 wt. %, 2 wt. % to 9 wt. %, 2 wt. % to 8 wt. %, 2 wt. % to 7 wt. %, 2 wt. % to 6 wt. %, 2 wt. % to 5 wt. %, 2 wt. % to 4 wt. %, 2 wt. % to 3 wt. %, 3 wt. % to 10 wt. %, 3 wt. % to 9 wt. %, 3 wt. % to 8 wt. %, 3 wt. % to 7 wt. %, 3 wt. % to 6 wt. %, 3 wt. % to 5 wt. %, 3 wt. % to 4 wt. %, 4 wt. % to 10 wt. %, 4 wt. % to 9 wt. %, 4 wt. % to 8 wt. %, 4 wt. % to 7 wt. %, 4 wt. % to 6 wt. %, 4 wt. % to 5 wt. %, 5 wt. % to 10 wt. %, 5 wt. % to 9 wt. %, 5 wt. % to 8 wt. %, 5 wt. % to 7 wt. %, 5 wt. % to 6 wt. %, 6 wt. % to 10 wt. %, 6 wt. % to 9 wt. %, 6 wt. % to 8 wt. %, 6 wt. % to 7 wt. %, 7 wt. % to 10 wt. %, 7 wt. % to 9 wt. %, 7 wt. % to 8 wt. %, 8 wt. % to 10 wt. %, 8 wt. % to 9 wt. %, or even from 9 wt. % to 10 wt. %, or a range where any two listed numbers comprise the endpoints of that range.

In one or more embodiments, the zeolite Beta may have a surface area from 100 m²/g to 800 m²/g. As used herein, “surface area” may refer to average surface area. Average surface area can be measured by Brunauer-Emmett-Teller (BET) analysis, as is known by those skilled in the art. A relatively high surface area of the zeolite Beta may increase the catalytic effectiveness of the catalyst, which is generally desirable. Without intending to be bound by any particular theory, it is believed that a surface area of the zeolitic material of less than 100 m²/g may result in a reduction in the number of available solid acid sites, thereby reducing the catalyst activity of the catalyst to an unsatisfactory level. Further, it is believed that a zeolitic material having a surface area of greater than 800 m²/g may be difficult to produce. For example, and without limitation, in one or more embodiments, the zeolite Beta may have a surface area from 100 m²/g to 800 m²/g, 100 m²/g to 700 m²/g, 100 m²/g to 600 m²/g, 100 m²/g to 500 m²/g, 100 m²/g to 400 m²/g, 100 m²/g to 300 m²/g, 100 m²/g to 200, 200 m²/g to 800 m²/g, 200 m²/g to 700 m²/g, 200 m²/g to 600 m²/g, 200 m²/g to 500 m²/g, 200 m²/g to 400 m²/g, 200 m²/g to 300 m²/g, 300 m²/g to 800 m²/g, 300 m²/g to 700 m²/g, 300 m²/g to 600 m²/g, 300 m²/g to 500 m²/g, 300 m²/g to 400 m²/g, 400 m²/g to 800 m²/g, 400 m²/g to 700 m²/g, 400 m²/g to 600 m²/g, 400 m²/g to 500 m²/g, 500 m²/g to 800 m²/g, 500 m²/g to 700 m²/g, 500 m²/g to 600 m²/g, 600 m²/g to 800 m²/g, 600 m²/g to 700 m²/g, or even from 700 m²/g to 800 m²/g, or a range where any two listed numbers comprise the endpoints of that range.

In one or more embodiments, the zeolite Beta may have a pore volume from 0.1 mL/g to 2.0 mL/g. As used in this disclosure, “pore volume” refers to the total pore volume of the pores of the zeolitic material per gram of the zeolitic material, measured by BET analysis. For example, and without limitation, in one or more embodiments, the zeolite Beta may have a pore volume from 0.1 mL/g to 2.0 mL/g, 0.1 mL/g to 1.8 mL/g, 0.1 mL/g to 1.6 mL/g, 0.1 mL/g to 1.4 mL/g, 0.1 mL/g to 1.2 mL/g, 0.1 mL/g to 1.0 mL/g, 0.1 mL/g to 0.8 mL/g, 0.1 mL/g to 0.6 mL/g, 0.1 mL/g to 0.4 mL/g, 0.1 mL/g to 0.2 mL/g, 0.2 mL/g to 2.0 mL/g, 0.2 mL/g to 1.8 mL/g, 0.2 mL/g to 1.6 mL/g, 0.2 mL/g to 1.4 mL/g, 0.2 mL/g to 1.2 mL/g, 0.2 mL/g to 1.0 mL/g, 0.2 mL/g to 0.8 mL/g, 0.2 mL/g to 0.6 mL/g, 0.2 mL/g to 0.4 mL/g, 0.4 mL/g to 2.0 mL/g, 0.4 mL/g to 1.8 mL/g, 0.4 mL/g to 1.6 mL/g, 0.4 mL/g to 1.4 mL/g, 0.4 mL/g to 1.2 mL/g, 0.4 mL/g to 1.0 mL/g, 0.4 mL/g to 0.8 mL/g, 0.4 mL/g to 0.6 mL/g, 0.6 mL/g to 2.0 mL/g, 0.6 mL/g to 1.8 mL/g, 0.6 mL/g to 1.6 mL/g, 0.6 mL/g to 1.4 mL/g, 0.6 mL/g to 1.2 mL/g, 0.6 mL/g to 1.0 mL/g, 0.6 mL/g to 0.8 mL/g, 0.8 mL/g to 2.0 mL/g, 0.8 mL/g to 1.8 mL/g, 0.8 mL/g to 1.6 mL/g, 0.8 mL/g to 1.4 mL/g, 0.8 mL/g to 1.2 mL/g, 0.8 mL/g to 1.0 mL/g, 1.0 mL/g to 2.0 mL/g, 1.0 mL/g to 1.8 mL/g, 1.0 mL/g to 1.6 mL/g, 1.0 mL/g to 1.4 mL/g, 1.0 mL/g to 1.2 mL/g, 1.2 mL/g to 2.0 mL/g, 1.2 mL/g to 1.8 mL/g, 1.2 mL/g to 1.6 mL/g, 1.2 mL/g to 1.4 mL/g, 1.4 mL/g to 2.0 mL/g, 1.4 mL/g to 1.8 mL/g, 1.4 mL/g to 1.6 mL/g, 1.6 mL/g to 2.0 mL/g, 1.6 mL/g to 1.8 mL/g, or even from 1.8 mL/g to 2.0 mL/g, or a range where any two listed numbers comprise the endpoints of that range.

Zeolite Betas, as described in the present disclosure, generally include a microporous structure and may, in some embodiments, additionally include mesopores. As used herein, a “microporous structure” refers to a structure in a material such as a zeolite having a pore size from 0.1 nm to 2 nm. The microporous structure of zeolite Betas may render large surface areas and desirable size-/shape-selectivity, which may be advantageous for catalysis. In embodiments described herein, the zeolite Betas may comprise micropores (present in the microstructure of a zeolite). The average pore size may be determined by Brunauer-Emmett-Teller (BET) analysis, a classification technique well understood by those skilled in the art.

In one or more embodiments, the zeolite Beta may have an average pore size from 0.1 nm to 2.0 nm (meaning that the zeolite Beta is not “mesoporous” and/or has a very low amount of mesopores present). For example, and without limitation, in one or more embodiments, the zeolite Beta may have an average pore size from 0.1 nm to 2.0 nm, 0.1 nm to 1.8 nm, 0.1 nm to 1.6 nm, 0.1 nm to 1.4 nm, 0.1 nm to 1.2 nm, 0.1 nm to 1.0 nm, 0.1 nm to 0.8 nm, 0.1 nm to 0.6 nm, 0.1 nm to 0.4 nm, 0.1 nm to 0.2 nm, 0.2 nm to 2.0 nm, 0.2 nm to 1.8 nm, 0.2 nm to 1.6 nm, 0.2 nm to 1.4 nm, 0.2 nm to 1.2 nm, 0.2 nm to 1.0 nm, 0.2 nm to 0.8 nm, 0.2 nm to 0.6 nm, 0.2 nm to 0.4 nm, 0.4 nm to 2.0 nm, 0.4 nm to 1.8 nm, 0.4 nm to 1.6 nm, 0.4 nm to 1.4 nm, 0.4 nm to 1.2 nm, 0.4 nm to 1.0 nm, 0.4 nm to 0.8 nm, 0.4 nm to 0.6 nm, 0.6 nm to 2.0 nm, 0.6 nm to 1.8 nm, 0.6 nm to 1.6 nm, 0.6 nm to 1.4 nm, 0.6 nm to 1.2 nm, 0.6 nm to 1.0 nm, 0.6 nm to 0.8 nm, 0.8 nm to 2.0 nm, 0.8 nm to 1.8 nm, 0.8 nm to 1.6 nm, 0.8 nm to 1.4 nm, 0.8 nm to 1.2 nm, 0.8 nm to 1.0 nm, 1.0 nm to 2.0 nm, 1.0 nm to 1.8 nm, 1.0 nm to 1.6 nm, 1.0 nm to 1.4 nm, 1.0 nm to 1.2 nm, 1.2 nm to 2.0 nm, 1.2 nm to 1.8 nm, 1.2 nm to 1.6 nm, 1.2 nm to 1.4 nm, 1.4 nm to 2.0 nm, 1.4 nm to 1.8 nm, 1.4 nm to 1.6 nm, 1.6 nm to 2.0 nm, 1.6 nm to 1.8 nm, or even from 1.8 nm to 2.0 nm, or a range where any two listed numbers comprise the endpoints of that range.

In one or more embodiments, the zeolite Beta may have a crystallinity greater than or equal to 90%. As described herein, the crystallinity of a sample may be measured with XRD (X-ray Diffraction). The crystallinity is measured in relative terms based on, generally, an initial sample being assigned 100% crystallinity, where other samples are calculated as having a crystallinity of greater than 100% if they have a crystallinity greater than the initial sample and a crystallinity less than 100% if crystallinity of the sample is less than the crystallinity of the initial sample. Such an initial sample is known to have about 100% crystallinity. From the XRD spectra, the five most intensive peaks are integrated. The sample relative crystallinity is calculated based on the following equation: X (%)=100%×ΣA/ΣA₀, where A is the sum of the five peaks' total area of the fabricated samples; A₀ is the sum of the five peaks' total area of the reference sample. For example, and without limitation, in one or more embodiments, the zeolite Beta may have a crystallinity greater than or equal to 90%, greater than or equal to 91%, greater than or equal to 92%, greater than or equal to 93%, greater than or equal to 94%, greater than or equal to 95%, greater than or equal to 96%, greater than or equal to 97%, greater than or equal to 98%, greater than or equal to 99%, or even greater than 100%.

In one or more embodiments, the zeolite Beta may comprise from 0 wt. % to 5 wt. % of a combination of phosphorus, boron, titanium, and zirconium, either alone or in combination, based on the total weight of the zeolite Beta. Without being bound theory, it is believed that phosphorus, boron, titanium, and/or zirconium may enhance the performance of the catalyst by modifying the acidity of the catalyst, which may improve the selectivity of the catalyst and/or improve the stability of the zeolite structure, thereby making the catalyst more resistant to deactivation over time. The amount of phosphorus, boron, titanium, and zirconium in the zeolitic material can be measured by, for example, an X-ray fluorescence analyzer, a high-frequency plasma emission spectrometer, an atomic absorption spectrometer, or the like. For example, and without limitation, in one or more embodiments, the zeolite Beta may not comprise any amount of phosphorus, boron, titanium, and zirconium, either alone or in combination (e.g., 0 wt. %). For example, and without limitation, in one or more embodiments, the zeolite Beta may comprise a combination of phosphorus, boron, titanium, and zirconium, either alone or in combination in an amount, based on the total weight of the zeolite Beta, from greater than 0 wt. % to 5 wt. %, from greater than 0 wt. % to 4 wt. %, from greater than 0 wt. % to 3 wt. %, from greater than 0 wt. % to 2 wt. %, from greater than 0 wt. % to 1 wt. %, from 1 wt. % to 5 wt. %, from 1 wt. % to 4 wt. %, from 1 wt. % to 3 wt. %, from 1 wt. % to 2 wt. %, from 2 wt. % to 5 wt. %, from 2 wt. % to 4 wt. %, from 2 wt. % to 3 wt. %, from 3 wt. % to 5 wt. %, from 3 wt. % to 4 wt. %, or even from 4 wt. % to 5 wt. %, or a range where any two listed numbers comprise the endpoints of that range.

In one or more embodiments, the zeolite Beta may be a nano-sized zeolite Beta. As described herein, “nano-sized” refers to zeolitic particles and/or crystals that have an average particle size of less than or equal to 100 nm. As described herein, the “average particle size” is the average of all particles of a certain type, such as zeolite Beta. As used in the present disclosure, “particle size” may be measured as the greatest distance between two points located on a single zeolite Beta particle. For example, the particle size of a spherical particle is equal to its diameter. In other shapes, the particle size is measured as the distance between the two most distant points of the same particle, where these points may lie on the outer surfaces of the particle. Average particle size can be determined using Scanning Electron Microscopy (“SEM”), where the particle size is measured as the longest distance in any dimension of a particle. Without being bound by theory, it is believed that the relatively small particle size allows for easier access by the molecules in heavy oil to active sites on the zeolite. For example, the increased external surface area may be caused by the small particle size, which may increase catalytic activity. For example, in one or more embodiments, the nano-sized zeolite Beta may have an average particle size ranging from 10 to 100 nm, such as 20 nm to 100 nm, 30 nm to 100 nm, 40 nm to 100 nm, 50 nm to 100 nm, 60 nm to 100 nm, 70 nm to 100 nm, 80 nm to 100 nm, 90 nm to 100 nm, 10 nm to 80 nm, 10 nm to 70 nm, 10 nm to 60 nm, 10 nm to 50 nm, 10 nm to 40 nm, 10 nm to 30 nm, or even from 10 nm to 20 nm, or a range where any two listed numbers comprise the endpoints of that range. The nano-sized zeolite Beta described herein may form as particles that may be generally spherical in shape or irregular-globular shaped (that is, non-spherical).

In one or more embodiments, the zeolite Betas described herein may be mesoporous zeolites, which refers to zeolites that have an average pore size of from 2 nm to 50 nm (the mesoporous range as recognized by IUPAC). Without being bound theory, it is believed that the relatively large pore size (e.g., 2 nm to 50 nm) of the presently described nano-sized mesoporous zeolite Beta, and catalysts that include the nano-sized mesoporous zeolite Beta, allow for larger molecules to diffuse inside the zeolite, which is believed to enhance the reaction activity and selectivity of the zeolite. With the increased pore size, aromatic-containing molecules may more easily diffuse into the zeolite Beta, and aromatic cracking may be increased. Thus, catalysts comprising zeolite Betas with relatively larger pore sizes (e.g., 2 nm to 50 nm) may have a superior catalytic performance as compared with conventional hydrocracking catalysts. For example, and without limitation, in one or more embodiments, the zeolite Beta may have an average pore size from 2 nm to 50 nm, 2 nm to 45 nm, 2 nm to 40 nm, 2 nm to 35 nm, 2 nm to 30 nm, 2 nm to 25 nm, 2 nm to 20 nm, 2 nm to 15 nm, 2 nm to 10 nm, 2 nm to 5 nm, 5 nm to 50 nm, 5 nm to 45 nm, 5 nm to 40 nm, 5 nm to 35 nm, 5 nm to 30 nm, 5 nm to 25 nm, 5 nm to 20 nm, 5 nm to 15 nm, 5 nm to 10 nm, 10 nm to 50 nm, 10 nm to 45 nm, 10 nm to 40 nm, 10 nm to 35 nm, 10 nm to 30 nm, 10 nm to 25 nm, 10 nm to 20 nm, 10 nm to 15 nm, 15 nm to 50 nm, 15 nm to 45 nm, 15 nm to 40 nm, 15 nm to 35 nm, 15 nm to 30 nm, 15 nm to 25 nm, 15 nm to 20 nm, 20 nm to 50 nm, 20 nm to 45 nm, 20 nm to 40 nm, 20 nm to 35 nm, 20 nm to 30 nm, 20 nm to 25 nm, 25 nm to 50 nm, 25 nm to 45 nm, 25 nm to 40 nm, 25 nm to 35 nm, 25 nm to 30 nm, 30 nm to 50 nm, 30 nm to 45 nm, 30 nm to 40 nm, 30 nm to 35 nm, 35 nm to 50 nm, 35 nm to 45 nm, 35 nm to 40 nm, 40 nm to 50 nm, 40 nm to 45 nm, or even from 45 nm to 50 nm, or a range where any two listed numbers comprise the endpoints of that range.

In one or more embodiments, the catalyst described herein may comprise from 10 wt. % to 80 wt. % of a support material, based on the total weight of the catalyst. In one or more embodiments, the support material may comprise amorphous silica alumina (ASA) and porous alumina. Without being bound theory, it is believed that ASA provides acid sites for cracking, while the porous alumina and the zeolite provide hydrogenation sites for hydrogen removal and addition. ASA is a relatively weak acid compared to zeolites and may help to rapidly hydrogenate olefins (e.g., unsaturated hydrocarbons) that are formed during the cracking process. This saturation (or hydrogenation) of olefins may reduce secondary cracking (e.g., where the desired cracked product undergoes further cracking to form smaller hydrocarbons). Thus, hydrocracking a hydrocarbon stream using the catalyst described herein may achieve a higher middle distillate yield than conventional hydrocracking catalysts. However, catalysts only comprising acid sites provided in the form of ASA may have too low of an activity. Accordingly, the catalyst described herein may comprise zeolites and/or porous alumina, which may enhance the activity of the catalyst while still maintaining a desirable middle distillate yield. For example, and without limitation, in one or more embodiments, the catalyst may comprise ASA in an amount, based on the total weight of the catalyst, from 20 wt. % to 70 wt. %, 10 wt. % to 65 wt. %, 10 wt. % to 60 wt. %, 10 wt. % to 55 wt. %, 10 wt. % to 50 wt. %, 10 wt. % to 45 wt. %, 10 wt. % to 40 wt. %, 10 wt. % to 35 wt. %, 10 wt. % to 30 wt. %, 10 wt. % to 25 wt. %, 10 wt. % to 20 wt. %, 10 wt. % to 15 wt. %, 15 wt. % to 70 wt. %, 15 wt. % to 65 wt. %, 15 wt. % to 60 wt. %, 20 wt. % to 70 wt. %, 20 wt. % to 65 wt. %, 20 wt. % to 60 wt. %, 20 wt. % to 55 wt. %, 20 wt. % to 50 wt. %, 20 wt. % to 45 wt. %, 20 wt. % to 40 wt. %, 20 wt. % to 35 wt. %, 20 wt. % to 30 wt. %, 20 wt. % to 25 wt. %, 25 wt. % to 70 wt. %, 25 wt. % to 65 wt. %, 25 wt. % to 60 wt. %, 25 wt. % to 55 wt. %, 25 wt. % to 50 wt. %, 25 wt. % to 45 wt. %, 25 wt. % to 40 wt. %, 25 wt. % to 35 wt. %, 25 wt. % to 30 wt. %, 30 wt. % to 70 wt. %, 30 wt. % to 65 wt. %, 30 wt. % to 60 wt. %, 30 wt. % to 55 wt. %, 30 wt. % to 50 wt. %, 30 wt. % to 45 wt. %, 30 wt. % to 40 wt. %, 30 wt. % to 35 wt. %, 35 wt. % to 70 wt. %, 35 wt. % to 65 wt. %, 35 wt. % to 60 wt. %, 35 wt. % to 55 wt. %, 35 wt. % to 50 wt. %, 35 wt. % to 45 wt. %, 35 wt. % to 40 wt. %, 40 wt. % to 70 wt. %, 40 wt. % to 65 wt. %, 40 wt. % to 60 wt. %, 40 wt. % to 55 wt. %, 40 wt. % to 50 wt. %, 40 wt. % to 45 wt. %, 45 wt. % to 70 wt. %, 45 wt. % to 65 wt. %, 45 wt. % to 60 wt. %, 45 wt. % to 55 wt. %, 45 wt. % to 50 wt. %, 50 wt. % to 70 wt. %, 50 wt. % to 65 wt. %, 50 wt. % to 60 wt. %, 50 wt. % to 55 wt. %, 55 wt. % to 70 wt. %, 55 wt. % to 65 wt. %, 55 wt. % to 60 wt. %, 60 wt. % to 70 wt. %, 60 wt. % to 65 wt. %, or even from 65 wt. % to 70 wt. %, or a range where any two listed numbers comprise the endpoints of that range.

In one or more embodiments, the ASA may comprise a molar ratio (silica-alumina ratio) of SiO₂ to Al₂O₃ of from 10:90 to 30:70. For example, and without limitation, in one or more embodiments, the ASA may comprise a molar ratio (silica-alumina ratio) of SiO₂ to Al₂O₃ of from 15:85, 20:80, 25:75, or any ratio therebetween.

In one or more embodiments, the catalyst described herein may comprise from 10 wt. % to 40 wt. % of porous alumina, based on the total weight of the catalyst. For example, and without limitation, in one or more embodiments, the catalyst may comprise porous alumina in an amount, based on the total weight of the catalyst, from 10 wt. % to 40 wt. %, 10 wt. % to 35 wt. %, 10 wt. % to 30 wt. %, 10 wt. % to 25 wt. %, 10 wt. % to 20 wt. %, 10 wt. % to 15 wt. %, 15 wt. % to 40 wt. %, 15 wt. % to 35 wt. %, 15 wt. % to 30 wt. %, 15 wt. % to 25 wt. %, 15 wt. % to 20 wt. %, 20 wt. % to 40 wt. %, 20 wt. % to 35 wt. %, 20 wt. % to 30 wt. %, 20 wt. % to 25 wt. %, 25 wt. % to 40 wt. %, 25 wt. % to 35 wt. %, 25 wt. % to 30 wt. %, 30 wt. % to 40 wt. %, 30 wt. % to 35 wt. %, or even from 35 wt. % to 40 wt. %, or a range where any two listed numbers comprise the endpoints of that range.

In one or more embodiments, the catalyst may comprise from 0.1 wt. % to 40 wt. % of the one or more metals, one or more metal oxides, or both, based on the total weight of the catalyst, wherein the one or more metals are chosen from IUPAC Group 8-10 and/or IUPAC Group 6, and the metal oxides are formed from such metals. In one or more embodiments, the IUPAC Group 8-10 metal is selected from a group consisting of iron, cobalt, and nickel. In one or more embodiments, the IUPAC Group 6 metal is selected from a group consisting of molybdenum and tungsten. As used in the present disclosure, the “one or more metals, one or more metal oxides, or both” may refer to a material distinct from the support material and/or the zeolitic material. The one or more metals, one or more metal oxides, or both, may be disposed on the microporous framework of the zeolitic material, the support material, or both. Without intending to be bound by any particular theory, it is believed that the inclusion of the one or more metals, one or more metal oxides, or both, may increase the hydrogenative activity of the catalyst. In one or more embodiments, the catalyst may comprise the one or more metals, one or more metal oxides, or both, wherein the one or more metals may be chosen from IUPAC Group 8-10 and/or IUPAC Group 6, or combinations thereof, in an amount, based on the total weight of the catalyst, from 0.1 wt. % to 40 wt. %, 0.1 wt. % to 35 wt. %, 1 wt. % to 30 wt. %, 1.5 wt. % to 25 wt. %, 2 wt. % to 20 wt. %, 2 wt. % to 15 wt. %, 5 wt. % to 35 wt. %, 5 wt. % to 30 wt. %, 5 wt. % to 25 wt. %, 5 wt. % to 20 wt. %, 5 wt. % to 15 wt. %, 10 wt. % to 40 wt. %, 10 wt. % to 35 wt. %, 10 wt. % to 30 wt. %, 10 wt. % to 25 wt. %, 10 wt. % to 20 wt. %, 10 wt. % to 15 wt. %, 15 wt. % to 40 wt. %, 15 wt. % to 35 wt. %, 15 wt. % to 30 wt. %, 15 wt. % to 25 wt. %, or even from 15 wt. % to 20 wt. %, or a range where any two listed numbers comprise the endpoints of that range. In one or more embodiments, the IUPAC Group 8-10 metal can be present in an amount greater than or equal to 0 wt. % to less than or equal to 20% wt. %, and the IUPAC Group 6 metal can be present in an amount greater than or equal to 1 wt. % and less than or equal to 25% wt. %. For example, without limitation, in some embodiments, the catalyst may comprise from 0.1 wt. % to 10 wt. % of nickel oxide and from 15 wt. % to 25 wt. % of tungsten trioxide.

### EXAMPLES

Examples are provided herein, which may disclose one or more embodiments of the present disclosure. However, the Examples should not be viewed as limiting on the claimed embodiments hereinafter provided.

### Example 1—Synthesis of Nano-Sized Zeolite Beta

To synthesize a nano-sized zeolite Beta, first, 0.51 grams (g) of alumina powder (CATAPAL® aluminas, commercially available from Sasol Limited of Johannesburg, South Africa) was combined with 25 g of 35% tetraethylammonium hydroxide (TEAOH) in a first beaker and stirred at room temperature (approximately 23° C.) until the alumina powder dissolved and a clear solution was formed. In a second beaker, 15 g of fumed silica, 38 g of 35% TEAOH, and 4.05 g of purified water were combined and mixed to form a slurry. Next, the clear solution from the first beaker was added to the slurry in the second beaker and mixed at room temperature (approximately 23° C.) for 4 hours to form an aluminosilicate gel. The aluminosilicate gel was subsequently transferred into a polytetrafluoroethylene (PTFE) lined stainless steel autoclave, sealed, and put into a rotating oven. The autoclave was rotated at 60 revolutions per minute (rpm) at a temperature of 140° C. for three days (e.g., approximately 72 hours) and then quenched with cold water (approximately 15° C.) for 1 hour. The colloid formed in the autoclave was then washed in a high-speed centrifuge in a repeated manner until the colloid had a pH of about 9.0. The washed and centrifuged colloid was then dried in an oven at a temperature of 110° C. overnight (approximately 12 hours) to form a dried product. The dried product was calcinated at a temperature of 550° C. for 4 hours, where the temperature was ramped up at a rate of 2° C. per minute to form the nano-sized zeolite Beta.

Textural properties of the nano-sized zeolite Beta were measured and are reported in Table 1. The SiO₂/Al₂O₃ molar ratio of the nano-sized zeolite Beta is also reported in Table 1.

TABLE 1

| Properties | Nano-sized Zeolite Beta |
|---|---|
| SiO₂/Al₂O₃ molar ratio | 25 |
| XRD crystallinity (CP-814E | 94.8 |
| used as a reference), % | |
| SEM particle size (nm) | 83 |
| BET surface area (m²/g) | 592 |
| pore volume (ml/g) | 0.83 |
| Average pore size (nm) | 5.61 |

### Example 2—Formation of a First Sample Catalyst S1 Including the Nano-Sized Zeolite Beta of Example 1

To form a first sample catalyst S1, including the nano-sized zeolite Beta synthesized in Example 1, first, an extrudate powder was prepared by mixing the synthesized nano-sized zeolite Beta, amorphous silica alumina (Siral 40 HPV, commercially available from Sasol Limited of Johannesburg, South Africa), and a first portion of boehmite (Catapal, commercially available from JGC Catalyst and Chemicals Ltd), in a ratio of 1:106:52. Boehmite refers to an aluminum-containing compound with the chemical composition of aluminum oxide hydroxide (AlO(OH)). Next, a binder solution was formed by peptizing a second portion of boehmite with an 11 wt. % nitric acid solution. The binder solution and water were added to the extrudate powder, and the mixture was mixed and kneaded to form an extrudate dough. A ratio of the boehmite in the extrudate powder to the boehmite in the binder solution was 52:40. The extrusion dough had a loss on ignition (LOI) of 65%. The extrudate dough was then extruded to form a catalyst support. The catalyst support was calcinated in a muff oven at a temperature of 630° C. for a time period of 1 hour. The calcined support was then impregnated with a liquid solution containing nickel nitrate and ammonia metatungstate to achieve metal loading of 5% Ni and 18% W. The impregnated catalyst was then calcinated at a temperature of 535° C. for a time period of 2 hours to form the first sample catalyst S1. Textural properties of the first sample catalyst S1 are reported in Table 2.

TABLE 2

| Property | S1 |
|---|---|
| Surface Area (m²/g) | 197.9 |
| Pore Volume (mL/g) | 0.4883 |
| Micropore Volume (mL/g) | <0.001 |
| Mesopore Volume (mL/g) | 0.4883 |
| Average Pore Size (nm) | 9.871 |

### Example 3—Formation of a Second Sample Catalyst S2 Including the Nano-Sized Mesoporous Zeolite Beta of Example 1

To form a second sample catalyst S2, including a nano-sized mesoporous zeolite Beta, first, a 0.5 molar basic aqueous solution comprising NH₄OH was combined with 0.1 moles of cetrimonium bromide (CTAB). The solution was stirred for a time period of 10 minutes. The nano-sized zeolite Beta synthesized in Example 1 was added to the solution in a volume (e.g., of the solution) to mass (e.g., of the nano-sized zeolite Beta) ratio of 1:20, and the mixture was stirred for 20 minutes to form a gel. The gel was heated in an autoclave at a temperature of 150° C. for 10 hours. The colloid formed in the autoclave was dried at a temperature of 110° C. for 16 h to form a dried product. The dried product was calcinated at a temperature of 550° C. for 4 hours, with a temperature ramp-up of 2° C. per minute, to form the nano-sized mesoporous zeolite Beta. Next, an extrudate powder was prepared by mixing the synthesized nano-sized mesoporous zeolite Beta, amorphous silica alumina (commercially available from Sasol Limited of Johannesburg, South Africa), and a first portion of boehmite (commercially available from JGC Catalyst and Chemicals Ltd.), in a ratio of 1:106:52. Next, a binder solution was formed by peptizing a second portion of boehmite with diluted nitric acid. The binder solution and water were added to the extrudate powder, and the mixture was mixed and kneaded to form an extrudate dough. A ratio of the boehmite in the extrudate powder to the boehmite in the binder solution was 52:40. The extrusion dough had a loss on ignition (LOI) of 65%. The extrudate dough was then extruded to form a catalyst support. The catalyst support was calcinated in a muff oven at a temperature between 500° C. to 700° C. for 1 hour. The calcined support was then impregnated with a liquid solution containing nickel nitrate and ammonia metatungstate to achieve metal loading of 5% Ni and 18% W. The impregnated catalyst was then calcinated at a temperature of 535° C. for 2 hours to form the second sample catalyst S2. Textural properties of the second sample catalyst S2 are reported in Table 3.

TABLE 3

| Property | S2 |
|---|---|
| Surface Area (m²/g) | 174 |
| Pore Volume (mL/g) | 0.4238 |
| Micropore Volume (mL/g) | 0.0066 |
| Mesopore Volume (mL/g) | 0.4172 |
| Average Pore Size (nm) | 9.74 |

### Example 3—Formation of a Comparative Catalyst C1 Comprising USY and ASA

Methods for making a comparative catalyst C1, including an ultra-stable Y-type zeolite and ASA, are described in U.S. Pat. No. 9,221,036, the entirety of which is incorporated by reference herein. In particular, the comparative catalyst C1 was prepared according to the process described in Example 5, “Hydrocracking Catalyst E.” See U.S. Pat. No. 9,221,036, page 16, column 2, line 66, to page 17, column 1, line 14. Textural properties of the comparative catalyst C1 are reported in Table 4.

TABLE 4

| Property | C1 |
|---|---|
| Surface Area (m²/g) | 218.9 |
| Pore Volume (mL/g) | 0.5001 |
| Micropore Volume (mL/g) | 0.0031 |
| Mesopore Volume (mL/g) | 0.4970 |
| Average Pore Size (nm) | 9.137 |

### Example 4—Hydrocracking Tests Using Sample Catalyst S1 and S2, and Comparative Catalyst C3

Several hydrocracking tests were performed to test the selection and efficiency of sample catalysts S1 and S2 and comparative catalyst C1. As a first step, sample catalysts S1 and S2 and comparative catalyst C1 were sulfided. A sulfiding feed comprising 2 wt. % sulfur and 10 parts per million (ppm) of nitrogen was prepared by blending straight run diesel with dimethyl disulfide (DMDS) and tributylamine. Each of the sample catalysts S1 and S2 and comparative catalyst C1 were dried at a temperature of 120° C. for 8 hours and then contacted with the sulfiding feed overnight (approximately 12 hours) at a temperature of 290° C. for 10 hours.

### Test A—Hydrocracking a Second Stage Hydrocracker Feed Utilizing Sample Catalyst S1 and Comparative C1

The sulfided sample catalyst S1 and comparative catalyst C1 were subjected to a hydrocracking test using a second stage hydrocracker feed having a density of 0.856 g/mL at 15° C. and a sulfur content of 21 ppm. The hydrocracker feed had a boiling point profile according to Table 5, as measured by gas chromatography ASTMD2887.

TABLE 5

| | Temperature (° C.) |
|---|---|
| Initial Boiling Point | 316.1 |
| 5 wt. % Boiling Point | 364.2 |
| 10 wt. % Boiling Point | 382.1 |
| 50 wt. % Boiling Point | 441.9 |
| 95 wt. % Boiling point | 541.6 |
| Final Boiling Point | 595.6 |

A microreactor was loaded with 3 mL of either the sample catalyst S1 or the comparative catalyst C1. The microreactor tests were conducted at a hydrogen partial pressure of 160 bar, a hydrogen/oil ratio of 675 StL/L of oil, a LHSV of 1.42 hr⁻¹, and reaction temperatures from 320° C. to 380° C. Table 6 shows a summary of the product yields of the hydrocracking tests utilizing sample catalyst S1 and comparative catalyst C1 at 60 wt. % conversion of the hydrocracker feed of Table 5

TABLE 6

| | | S1 Product | C1 Product |
|---|---|---|---|
| Hydrocarbon | Product | Yield | Yield |
| Product | Boiling Point | (wt. %) | (wt. %) |
| Diesel yield | 250° C.-375° C. | 25.3 | 17.8 |
| Kerosene yield | 150° C.-250° C. | 15.8 | 16.1 |
| Heavy Naphtha yield | 75° C.-150° C. | 11.3 | 16.5 |
| Light Naphtha yield | C₅⁺-75° C. | 4.0 | 5.4 |
| Gas yield | C₁-C₄ | 3.6 | 4.2 |

As shown in Table 6, the hydrocracking process utilizing sample catalyst S1 achieved a middle distillate yield (e.g., diesel and kerosene yield) of 41.1%. Whereas, the hydrocracking process utilizing comparative catalyst C1 only achieved a middle distillate yield of 33.9%. Accordingly, the hydrocracking process utilizing the sample catalyst S1 achieved a 7.2% higher yield of middle distillate products compared to the hydrocracking process utilizing the comparative catalyst C1.

### Test B—Hydrocracking a First Stage Hydrocracker Feed Utilizing Sample Catalyst S1 and Comparative Catalyst C1

The sulfided sample catalysts S1 and comparative catalyst C1 were subjected to a hydrocracking test using a first stage hydrocracker feed having a density of 0.942 g/mL at 15° C., a sulfur content of 3.7 wt. %, and a nitrogen content of 963 ppm. The hydrocracker feed had a boiling point profile according to Table 7, as measured by gas chromatography ASTMD2887.

TABLE 7

| | Temperature (° C.) |
|---|---|
| Initial Boiling Point | 311.0 |
| 5 wt. % Boiling Point | 361.2 |
| 10 wt. % Boiling Point | 379.0 |
| 50 wt. % Boiling Point | 451.7 |
| 95 wt. % Boiling point | 552.1 |
| Final Boiling Point | 607.0 |

A pretreat reactor of a microreactor system was loaded with 3 mL of commercial pretreated catalyst. The temperature of the pretreat reactor was adjusted to maintain a nitrogen slip of 100 ppm. The product from the pretreat reactor was fed to a hydrocracker of the microreactor. The hydrocracker was loaded with 3 mL of either the sample catalyst S1 or the comparative catalyst C1. During the microreactor tests, both the pretreat reactor and the hydrocracker were operated at a hydrogen partial pressure of 140 bar, a hydrogen/oil ratio of 1350 StL/L of oil, a LHSV of 1.74 hr⁻¹, and a reaction temperature from 350° C. to 420° C. Table 8 shows a summary of the product yields of the hydrocracking tests utilizing sample catalyst S1 and comparative catalyst C1 at a 60 wt. % conversion of the hydrocracker feed of Table 7.

TABLE 8

| | | S2 Product | C1 Product |
|---|---|---|---|
| Hydrocarbon | Product | Yield | Yield |
| Product | Boiling Point | (wt. %) | (wt. %) |
| Diesel yield | 250° C.-375° C. | 31.8 | 25.7 |
| Kerosene yield | 150° C.-250° C. | 15.1 | 17.5 |
| Heavy Naphtha yield | 75° C.-150° C. | 8.1 | 11.2 |
| Light Naphtha yield | C₅⁺-75° C. | 1.8 | 2.4 |
| Gas yield | C₁-C₄ | 2.0 | 2.0 |

As shown in Table 8, the hydrocracking process utilizing sample catalyst S1 achieved a middle distillate yield (e.g., diesel and kerosene yield) of 46.9%. Whereas, the hydrocracking process utilizing comparative catalyst C1 only achieved a middle distillate yield of 43.2%. Accordingly, the hydrocracking process utilizing sample catalyst S1 achieved a 3.7% higher yield of middle distillate products, compared to the hydrocracking process utilizing the comparative catalyst C1.

### Test 3—Hydrocracking a Second Stage Hydrocracker Feed Utilizing Sample Catalyst S2 and Comparative Catalyst C1

The sulfided sample catalyst S2 and comparative catalyst C1 were subjected to a hydrocracking test using a second stage hydrocracker feed having a density of 0.856 g/mL at 15° C. and a sulfur content of 21 ppm. The hydrocracker feed had a boiling point profile according to Table 9, as measured by gas chromatography ASTMD2887.

TABLE 9

| | Temperature (° C.) |
|---|---|
| Initial Boiling Point | 316.1 |
| 5 wt. % Boiling Point | 364.2 |
| 10 wt. % Boiling Point | 382.1 |
| 50 wt. % Boiling Point | 441.9 |
| 95 wt. % Boiling point | 541.6 |
| Final Boiling Point | 595.6 |

A microreactor was loaded with 3 mL of either sample catalyst S2 or comparative catalyst C1. Microreactor tests were conducted at a hydrogen partial pressure of 160 bar, a hydrogen/oil ratio of 675 StL/L of oil, a LHSV of 1.42 hr⁻¹, and reaction temperatures from 320° C. to 380° C. Table 10 shows a summary of the product yields of the hydrocracking tests utilizing sample catalyst S1 and comparative catalyst C1 at 60 wt. % conversion of the hydrocracker feed of Table 9.

TABLE 10

| | | S2 Product | C1 |
|---|---|---|---|
| Hydrocarbon | Product | Yield | Yield |
| Product | Boiling Point | (wt. %) | (wt. %) |
| Diesel | 250° C.-375° C. | 22.7 | 17.8 |
| Kerosene | 150° C.-250° C. | 15.7 | 15.9 |
| Heavy Naphtha | 75° C.-150° C. | 10.6 | 16.6 |
| Light Naphtha | C₅⁺-75° C. | 5.7 | 5.5 |
| Gas | C₁-C₄ | 5.3 | 4.3 |

As shown in Table 10, the hydrocracking process utilizing sample catalyst S2 achieved a middle distillate yield (e.g., diesel and kerosene yield) of 38.4%. Whereas, the hydrocracking process utilizing comparative catalyst C1 only achieved a middle distillate yield of 33.7%. Accordingly, the hydrocracking process utilizing the sample catalyst S2 achieved a 4.7% higher yield of middle distillate products, compared to the hydrocracking process utilizing the comparative catalyst C1.

Based on the foregoing, it should now be understood that the catalysts described herein exhibit an improved selection and efficiency for the production of middle distillate products produced from a hydrocracking process.

A first aspect of the present disclosure is directed to a method of cracking a hydrocarbon feed, the method comprising contacting the hydrocarbon feed with a catalyst in the presence of molecular hydrogen to crack at least a portion of the hydrocarbon feed to form a product; wherein the catalyst comprises: from 0.1 wt. % to 10 wt. % of a zeolite Beta having an average particle size less than or equal to 100 nm; from 20 wt. % to 70 wt. % of amorphous silica alumina; from 10 wt. % to 40 wt. % of porous alumina; and from 10 wt. % to 35 wt. % of one or more metal oxides; and wherein the hydrocarbon feed has a 5 wt. % boiling point from 250° C. to 500° C. and a 95 wt. % boiling point from 450° C. to 650° C.

A second aspect of the present disclosure may include the first aspect, wherein the hydrocarbon feed has an initial boiling point from 200° C. to 450° C. and a final boiling point from 500° C. to 800° C.

A third aspect of the present disclosure may include either one of the first aspect or the second aspect, wherein the product comprises greater than or equal to 35 wt. % of hydrocarbons having a boing point in a range of from 150° C. to 375° C.

A fourth aspect of the present disclosure may include any one of the first through third aspects, wherein the product comprises greater than or equal to 40 wt. % of hydrocarbons having a boing point in a range of from 150° C. to 375° C.

A fifth aspect of the present disclosure may include any one of the first through fourth aspects, wherein the product comprises greater than or equal to 20 wt. % of hydrocarbons having a boiling point in a range of from 250° C. to 375° C.

A sixth aspect of the present disclosure may include any one of the first through fifth aspects, wherein the catalyst comprises from 0.1 wt. % to 1 wt. % of the zeolite Beta having a particle size of less than or equal to 100 nm.

A seventh aspect of the present disclosure may include any one of the first through sixth aspects, wherein the catalyst comprises from 50 wt. % to 60 wt. % of the amorphous silica alumina.

An eighth aspect of the present disclosure may include any one of the first through seventh aspects, wherein the catalyst comprises from 10 wt. % to 20 wt. % of porous alumina.

A ninth aspect of the present disclosure may include any one of the first through eighth aspects, wherein the one or more metal oxides comprise: nickel oxide in an amount of from 0 wt. % to 10 wt. %, based on the total weight of the catalyst; and tungsten trioxide in an amount of from 15 wt. % to 25 wt. %, based on the total weight of the catalyst.

A tenth aspect of the present disclosure may include any one of the first through ninth aspects, wherein the zeolite Beta has a surface area greater than or equal to 100 m²/g.

An eleventh aspect of the present disclosure may include any one of the first through tenth aspects, wherein the zeolite Beta has a surface area from 500 m²/g to 800 m²/g.

A twelfth aspect of the present disclosure may include any one of the first through eleventh aspects, wherein the zeolite Beta has a total pore volume from 0.1 mL/g to 2.0 mL/g.

A thirteenth aspect of the present disclosure may include any one of the first through twelfth aspects, wherein the zeolite Beta has a total pore volume greater than or equal to 0.8 mL/g.

A fourteenth aspect of the present disclosure may include any one of the first through thirteenth aspects, wherein the zeolite Beta has an average pore size of from 2 nm to 50 nm.

A fifteenth aspect of the present disclosure may include any one of the first through fourteenth aspects, wherein the zeolite Beta has an average pore size less than or equal to 2 nm.

A sixteenth aspect of the present disclosure may include any one of the first through fifteenth aspects, wherein the zeolite Beta has a crystallinity greater than or equal to 90%.

A seventeenth aspect of the present disclosure may include any one of the first through sixteenth aspects, wherein the zeolite Beta comprises from 0 wt. % to 5 wt. % of a combination of phosphorus, boron, titanium, and zirconium.

An eighteenth aspect of the present disclosure may include any one of the first through seventeenth aspects, wherein the amorphous silica alumina comprises a mass ratio of alumina to silica of from 10:90 to 30:70.

A nineteenth aspect of the present disclosure may include any one of the first through eighteenth aspects, wherein the one or more metal oxides comprise a metal selected from the group consisting of iron, cobalt, and nickel, molybdenum, and tungsten, and combinations thereof.

A twentieth aspect of the present disclosure may any one of the first through nineteenth aspects, wherein: the zeolite Beta has a surface area greater than or equal to 180 m²/g; the zeolite Beta has a total pore volume from 0.5 mL/g to 1.0 mL/g; the zeolite Beta has an average pore size from 2 nm to 50 nm; the amorphous silica alumina comprises a mass ratio of alumina to silica of from 10:90 to 30:70; and the product comprises greater than or equal to 35 wt. % of hydrocarbons having a boiling point from 150° C. to 375° C.

The subject matter of the present disclosure has been described in detail and by reference to specific embodiments. It should be understood that any detailed description of a feature of an embodiment does not necessarily imply that the feature is essential to the particular embodiment or to any other embodiment. Further, it should be apparent to those skilled in the art that various modifications and variations can be made to the described embodiments without departing from the spirit and scope of the claimed subject matter.

For the purposes of describing and defining the present disclosure it is noted that the terms “about” or “approximately” are utilized in this disclosure to represent the inherent degree of uncertainty that may be attributed to any quantitative comparison, value, measurement, or other representation. The terms “about” and/or “approximately” are also utilized in this disclosure to represent the degree by which a quantitative representation may vary from a stated reference without resulting in a change in the basic function of the subject matter at issue.

It should be understood that any two quantitative values assigned to a property may constitute a range of that property, and all combinations of ranges formed from all stated quantitative values of a given property are contemplated in this disclosure.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.” It should be understood that where a first component is described as “comprising” a second component, it is contemplated that, in some embodiments, the first component “consists” or “consists essentially of” that second component. The transitional phrase “consisting of” excludes any element, step, or ingredient not specified in the claim, and the transitional phrase “consisting essentially of” is a limitation to the specified materials or steps and those that do not materially affect the basic and novel characteristics of the claimed embodiment.

What is claimed is:

1. A method of cracking a hydrocarbon feed, the method comprising contacting the hydrocarbon feed with a catalyst in the presence of molecular hydrogen to crack at least a portion of the hydrocarbon feed to form a product;
wherein the catalyst comprises:
from 0.1 wt. % to 10 wt. % of a zeolite Beta having an average particle size less than or equal to 100 nm;
from 20 wt. % to 70 wt. % of amorphous silica alumina;
from 10 wt. % to 40 wt. % of porous alumina; and
from 10 wt. % to 35 wt. % of one or more metal oxides; and
wherein the hydrocarbon feed has a 5 wt. % boiling point from 250° C. to 500° C. and a 95 wt. % boiling point from 450° C. to 650° C.

2. The method of claim 1, wherein the hydrocarbon feed has an initial boiling point from 200° C. to 450° C. and a final boiling point from 500° C. to 800° C.

3. The method of claim 1, wherein the product comprises greater than or equal to 35 wt. % of hydrocarbons having a boing point in a range of from 150° C. to 375° C.

4. The method of claim 1, wherein the product comprises greater than or equal to 40 wt. % of hydrocarbons having a boing point in a range of from 150° C. to 375° C.

5. The method of claim 1, wherein the product comprises greater than or equal to 20 wt. % of hydrocarbons having a boiling point in a range of from 250° C. to 375° C.

6. The method of claim 1, wherein the catalyst comprises from 0.1 wt. % to 1 wt. % of the zeolite Beta having a particle size of less than or equal to 100 nm.

7. The method of claim 1, wherein the catalyst comprises from 50 wt. % to 60 wt. % of the amorphous silica alumina.

8. The method of claim 1, wherein the catalyst comprises from 10 wt. % to 20 wt. % of porous alumina.

9. The method of claim 1, wherein the one or more metal oxides comprise:
nickel oxide in an amount of from 0 wt. % to 10 wt. %, based on the total weight of the catalyst; and
tungsten trioxide in an amount of from 15 wt. % to 25 wt. %, based on the total weight of the catalyst.

10. The method of claim 1, wherein the zeolite Beta has a surface area greater than or equal to 100 m²/g.

11. The method of claim 1, wherein the zeolite Beta has a surface area from 500 m²/g to 800 m²/g.

12. The method of claim 1, wherein the zeolite Beta has a total pore volume from 0.1 mL/g to 2.0 mL/g.

13. The method of claim 1, wherein the zeolite Beta has a total pore volume greater than or equal to 0.8 mL/g.

14. The method of claim 1, wherein the zeolite Beta has an average pore size of from 2 nm to 50 nm.

15. The method of claim 1, wherein the zeolite Beta has an average pore size less than or equal to 2 nm.

16. The method of claim 1, wherein the zeolite Beta has a crystallinity greater than or equal to 90%.

17. The method of claim 1, wherein the zeolite Beta comprises from 0 wt. % to 5 wt. % of a combination of phosphorus, boron, titanium, and zirconium.

18. The method of claim 1, wherein the amorphous silica alumina comprises a mass ratio of alumina to silica of from 10:90 to 30:70.

19. The method of claim 1, wherein the one or more metal oxides comprise a metal selected from the group consisting of iron, cobalt, and nickel, molybdenum, and tungsten, and combinations thereof.

20. The method of claim 1, wherein:
the zeolite Beta has a surface area greater than or equal to 180 m²/g;
the zeolite Beta has a total pore volume from 0.5 mL/g to 1.0 mL/g;
the zeolite Beta has an average pore size from 2 nm to 50 nm;
the amorphous silica alumina comprises a mass ratio of alumina to silica of from 10:90 to 30:70; and
the product comprises greater than or equal to 35 wt. % of hydrocarbons having a boiling point from 150° C. to 375° C.
